(19) United States
(12) Patent Application Publication
(10) Pub. No.: US 2005/0235140 A1
(43) Pub. Date: Oct. 20, 2005

(54) System and method for secure preservation and long term archival of electronic documents

(76) Inventors: Chi-kwong Hui, Hong Kong (CN); Kam-pui Chow, Hong Kong (CN); Chan-fung Chong, Hong Kong (CN); Kwok-hung Pun, Hong Kong (CN); Wai-wan Tsang, Hong Kong (CN); Hak-wai Chan, Hong Kong (CN); Kin-ying Yu, Hong Kong (CN)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/077,128

(22) Filed: Mar. 11, 2005

(30) Foreign Application Priority Data
Mar. 11, 2004 (HK) 1062121

(51) Int. Cl. H04L 9/00

(52) U.S. Cl. 713/156

(57) ABSTRACT

A method and system for long term electronic document archiving. The system collects a certificate revocation information for a certificate from a certificate authority that indicates the validity of the certificate used in an electronic document. The certificates are collected from a certificate authority. The system then generates at least two layers of signature and timestamp from the electronic document, certificate revocation information collected, and the collected certificate. Cryptographic primitives of different strength are used, and the two layers of signature and timestamp generated have different cryptographic strengths. The signature is generated using a system signing key whereas the timestamp is generated by an external entity. A digital aging token is then formed by combining the original electronic document, certificate revocation information, and certificate collected to the layers generated.

### FIELD OF THE INVENTION

The present invention relates to the long term archival of electronic documents, and more particular, to secure archival of electronic documents.

### BACKGROUND OF THE INVENTION

The use of electronic documents is more and more common nowadays. As a result, the ways of storing electronic documents have been changed. In the past, people usually created documents in handwritten form, typed the content into a computer, and printed the document into physical format again. The electronic copies of the documents are kept for reference purpose only. Nowadays, as more digital resources are available, storing documents in electronic format provides much more benefit then traditional format. Physical resources can be saved. One piece of paper can store several thousand words, while one floppy disk can store several million words. Moreover, with the advance of communication technology, documents in electronic format can be transmitted to another part of the world in only a few seconds, without any cost at all. To reduce the use of physical resources, some electronic documents only exist in the digital world and will never be transformed into physical format.

A digital signature scheme was suggested to authenticate electronic documents. Although the nature of digital signatures is similar to handwritten signatures, digital signatures have different properties from handwritten signatures. A digital signature require no physical medium, is harder to date and is more susceptible to tampering. One digital signature scheme is based on public key cryptography. To prevent signing keys being lost or compromised, fixed lifespans for digital signatures have to be set according to the strength for the public key cryptographic algorithm employed. Moreover, the public key infrastructure (PKI) is developed to support signer identification, certificate issuance and revocation mechanism. Some types of electronic documents, such as contracts and court statements, have very long life spans. This raises the need for digital signatures with long lifespans. However, digital signatures must have short lifespans to reduce the possible effect of a particular signing key being stolen or being compromised by attackers. A digital time-stamping scheme attempts to protect digital signatures, but it overlooks the fact that digital time-stamps also have to be protected. Thus, digital timestamps will be rendered invalid once the underlying signing algorithm expires. This invention proposes a digital aging scheme, a scheme which enables long term preservation of an electronic document and its authentication.

### SUMMARY OF THE INVENTION

In accordance with the present invention, it is an object of the present invention to provide a long term archival method for the preservation of an electronic document.

Another object of the invention is to use two digital signatures together with digital time-stamping, where the signing keys of different strength are used to sign the document and the weakest key should have the strength of current grade of cryptographic standard.

Yet another object of the present invention is to provide an effective way to renew the digital signatures and time-stamps before the signing keys or the underlying cryptographic-algorithms expire.

Still another object of the invention is to provide a means to protect an electronic document with only one digital signature for a long term, wherein the protection would be broken the digital signature or the signing key is compromised if the present invention is not applied.

A still further object of the invention is to provide a means to protect an electronic document with one digital signature which uses a signing key of higher strength than current grade of cryptographic standard, wherein the protection would be broken if the digital signature or the signing key is compromised.

Still another object of the invention is to provide a means to verify the correctness of digital signature even after the digital signature or the signing key is compromised at that point of time.

These and other objects of the invention are achieved by the designed scheme, systems, methods and a special data structure. The designed scheme uses repeated affiliation of a special “aging” process. During this process, digital signature and related authentication information, called an aging token, will be created. In this process, the processing time and storage requirement is same as creating one digital signature scheme.

A special data structure, which links the document, digital signature and digital timestamp, is employed. An XML layout and definition is used to represent the data structure. A graphical layout is used to reflect the structure of the token created by the scheme. A software architecture is used to carry out the scheme. A software program is used to achieve the scheme.

An advantageous implementation of the present invention is for providing a simple and effective scheme to support long term preservation of electronic documents so that electronic documents are protected from unexpected expiry of cryptographic keys and cryptographic algorithms, wherein traditional digital signature scheme cannot provide such kind of protection.

Other features and advantages of the present invention will become apparent to one with skill in the art upon examination of the following drawings and detailed description. It is intended that all such additional features and advantages be included herein within the scope of the present invention, as defined in the appended claims. Furthermore, as will be appreciated by those of skill in the art, the described methods of the invention may be provided as apparatus or computer readable program means.

### BRIEF DESCRIPTION OF THE DRAWING FIGURES

FIG. 1 is a block diagram illustrating the process and method in accordance with the invention.

FIG. 2 is a block diagram of the software architecture in accordance with the invention.

FIGS. 3A and 3B are diagrams describing the integrity protection function and the digital aging function, which are portions of the process and method of FIG. 1 and FIG. 2 for processing an existing electronic document or digital aging token and transforming it into a new digital aging token.

FIGS. 4A and 4B are diagrams listing the digital aging layering algorithm and the digital aging verification algorithm in accordance with the invention.

FIG. 5 is a diagram illustrating the generic structure of a digital aging token in accordance with the invention.

FIG. 6 is a diagram illustrating the generic layout of a digital aging token in accordance with the invention.

FIG. 7 is a diagram illustrating the XML data type definition of a digital aging token in accordance with the invention.

FIG. 8 is a block diagram illustrating the digital aging module in accordance with the present invention situated within a computer readable medium in a computer system.

### GLOSSARY

The following are the definitions in the art and their corresponding notation to aid in the understanding of the description.

Public key cryptographic primitive: With a key pair <K, K⁻¹>, where K is the public key and K⁻¹ is the private key, and a message m, encryption of message by a public key cryptographic primitive is denoted by {m}K, and it can only be decrypted by K⁻¹.

One way hash function: a hash function is a computationally efficient function mapping binary strings of arbitrary length to a binary string of fixed length. A collision resistant hash function is a hash function h that for a given message m, is computational infeasible with the current technology to find another message m′ such that h(m)=h(m′).

Signing function: With public key cryptography, signing with a particular signing key is similar to encrypt a message with the signing key as the private encryption key. For a signing key=K, signature=σ (m, K). Relevant information such as the original message, algorithm identifier, and the signer certificates should also be stored along with the signature.

Timestamping function: In this invention, we do not assume any underlying structure used by a particular timestamping authority (TSA). Therefore, a time-stamp is denoted with a similar notation as a signed object in our scheme. For a signature key=K_{TSA}, timestamp _{T} (m, K_{TSA}). As mentioned, timestamp is a signed object. Apart from the digest of the original message, the timestamp contains the TSA generated nonce, TSA certified time and date, TSA generated serial number and TSA provided data.

### DETAILED DESCRIPTION OF THE INVENTION

The present invention now will be described in more detail with reference to the accompanying drawings, in which preferred embodiments of the invention are shown. The present invention may be embodied in many different forms and should not be constructed as limited to the embodiment set forth herein. These embodiments are provided so that this document will be thorough and complete, to those skilled in the art. In the drawings, like numerals designate corresponding parts throughout the several views.

The present invention proposed a new scheme, called “digital aging” scheme. The scheme guarantees that valid evidence for integrity and authentication of a particular electronic document is always presented.

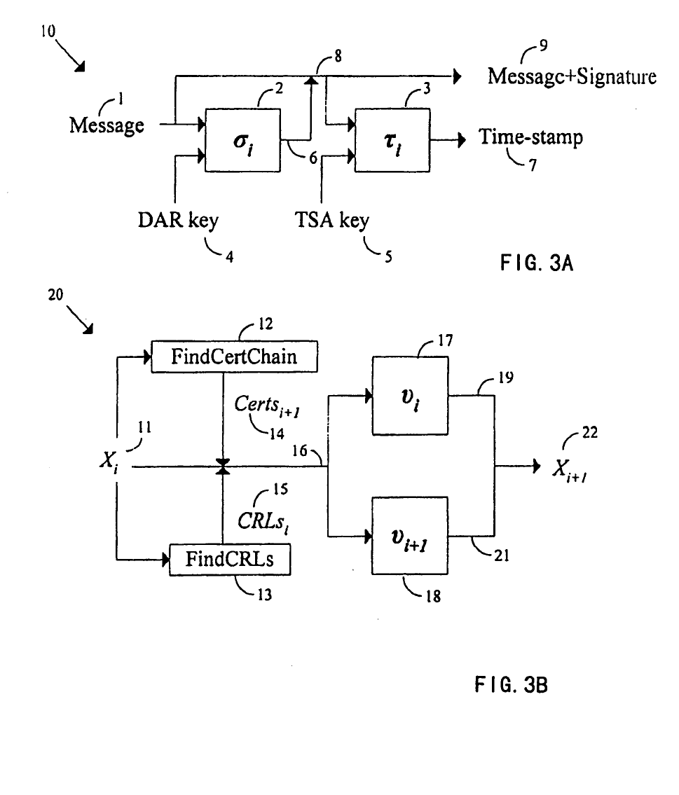

FIGS. 3A and 3B are the core part of the digital aging process. FIG. 3A illustrates the integrity protection function 10 which is responsible for providing basic protection of integrity of a given message 1. We define the integrity protection function 10 as νᵢ, which combined the signature function 2 σᵢ and the timestamping function 3 τ_{I}, to protect the integrity of a given message 1. When a signature is presented together with the time-stamp, the creation time of a particular signature can be verified, providing that the time-stamp can be verified. The time dimension is captured by the time period identifier i as it is in the signature function 2 σᵢ; and the timestamping function 3 τ_{I}. The subscript i is the time period identifier, where the system believes that the function is secure and will not be compromised before the time moment tᵢ₊₁.

The input for the signature function 2 σᵢ is the message I and the signing key 4 of the digital archive system (DAR). The output of the function 2 is the signature 6 of the message 1 signed with the key 4. The message 1 and the signature 4 become the input 8 of the function 3, together with the signing key 5 of the timestamping authority (TSA). Timestamp 7 of the input is the output of the function 3. Together with the message, signature, the integrity protection function is defined as
νᵢ(m)={m, signature timestamp}

Again, the subscript i is the time period identifier, where the system believes that the function is secure and will not be compromised before the time moment tᵢ₊₁.

Although signing keys should be input to the signing function and time-stamping function, this is assumed to be done by the digital archive system (DAR) and the timestamping authority (TSA). User clients should not have any access to the keys.

FIG. 3B illustrates the core of digital aging, the digital aging function 20 αᵢ. The input of the function αᵢ is the document token 11 xᵢ. The document token 11 contains the signed message and the certificate used. The function FindCRLs 13 retrieves the most updated certificate revocation information (CRL) 15 of the certificates which have been used in the document token xᵢ. FindCertChain 12 collects the certificates 14 that will be used in the function νᵢ 17 and νᵢ₊₁ 18. In this document, we refer such kind of certificate revocation information as CRL, for it is widely adapted as a standard kind of certificate revocation information in the PKI. However, such kind of certificate revocation information is not limited in the present invention and can be applied to other standards such as OCSP, CRT and delta CRL.

νᵢ 17 is the integrity protection function 10 described in FIG. 3A. νᵢ 17 is secure and sufficient for providing document integrity and authentication protection before the time moment tᵢ₊₁, but may not be secure afterwards. νᵢ₊₁ 18, on the other hand, is secure before the time moment tᵢ₊₂ and it is more complicated than νᵢ. Thus the output 22 of αᵢ consists of two layers of signature and time stamp.

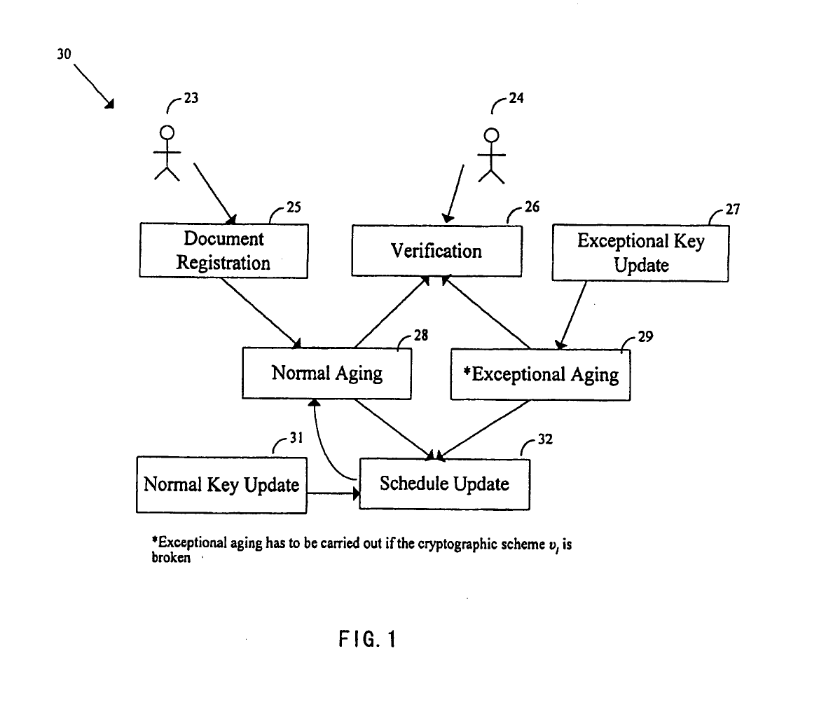

FIG. 1 illustrates the process and method of digital aging 30. The process of digital aging is described with the aid of the digital aging function 20 αᵢ. In a digital archival system, a user client 23 first submits a document, which can be either signed or unsigned by him, to the archival system. This process is called document registration 25. In this process, DAR will collect the user certificate if the document is signed. Denote this moment as to, the document as doc and the certificate as cert.sub.user. DAR will create the digital aging token xₒ which is the combination of doc and cert.sub.user. In this document, we denote digital aging token by the notation xᵢ. Then the registration process will pass the document token xₒ to the normal digital aging process 28.

xᵢ will be retrieved from the archive at time moment tᵢ. Message, certificates, signatures and timestamps in xᵢ will be verified. If the digital aging token is valid, then the new document token xᵢ₊₁ will be created by αᵢ with the aging token xᵢ. Since xᵢ consist of two layer of signature and timestamp, and in which at least one layer is verified as valid in the current time, we can discard the outer layer or the invalid layer of the aging token xᵢ and form the modified layer x′ᵢ. Then,
xᵢ₊₁=α(x′ᵢ)

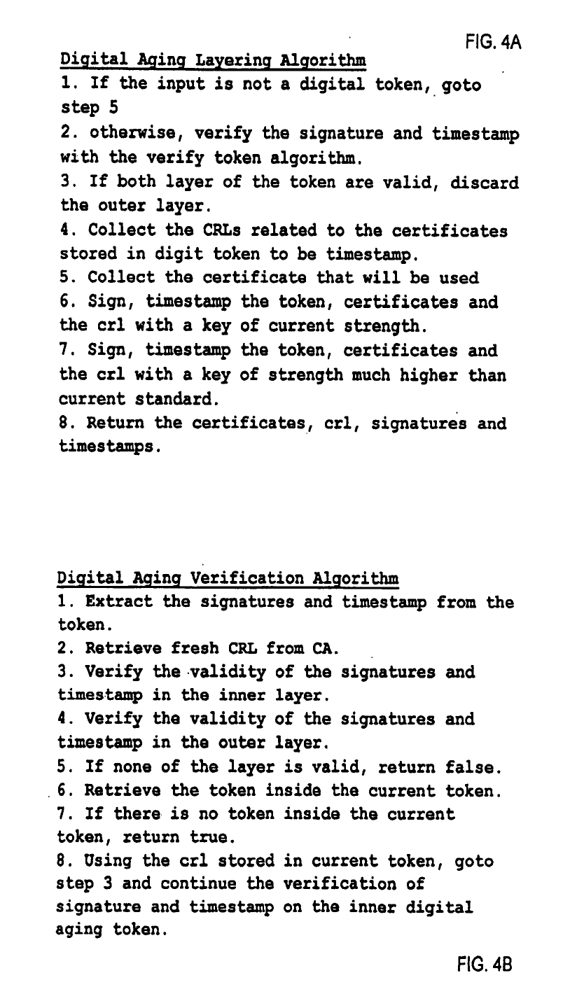

The algorithm listing of the digital aging layering algorithm is illustrated in FIG. 4A, which is an equivalent translation of the above process.

After normal digital aging 28 is carried out, the next time for the next normal digital aging process has to be scheduled for the token xᵢ₊₁. The time scheduled for next digital aging is set to the time moment before the most recent expiry date among the certificates stored in that document token xᵢ₊₁. This is done by the schedule update process 32.

Before reaching the schedule time, DAR and TSA may constantly update their signing keys. As times goes by, an algorithm which was secure in the past may not be secure anymore. One example is that longer modulus of RSA public key encryption system would bring to the system a more secure signing function. Therefore, DAR and TSA may also periodically update their cryptographic algorithms such as the signing function and the timestamping function. These events are detected by the normal key update process 31. When normal key update process detects these events, the process will request the system to set a closer schedule for updating the document token with the new cryptographic algorithms or cryptographic keys.

In normal digital aging process 28, the system has assumed νᵢ 17 is secure before tᵢ₊₁ However, if the underlying cryptographic primitive or cryptographic keys used by νᵢ is broken at some time moment t where t lies in the time interval (t; tᵢ₊₁), then the system will be aware of it. This is done by the exceptional key update process 27. The system will perform the exceptional digital aging process 29. tᵢ₊₁ will then be set to t. Although signature and time-stamp produced by νᵢ at tᵢ can not be verified, the signature and time-stamp produced by νᵢ₊₁ is still secure and can be verified. Still, we use the digital aging function to perform digital aging, where xᵢ₊₁=αᵢ (x′ᵢ), and x′ᵢ contains only the valid layer of xᵢ.

Whenever a digital aging token xᵢ is updated, the token is first verified. This is denoted by the verification process 26. To verify a token, the signature and timestamp inside the token are verified first. If they are valid at the current time moment, we can assume the content related to the signature and time stamp are valid from time period tᵢ to tᵢ₊₁. Therefore we can further verify the token xᵢ₊₁ inside the token xᵢ recursively. The process does not stop until one of the tokens cannot be verified or the token is proved to be valid from tₒ to tᵢ₊₁. The verification algorithm is listed in FIG. 4B.

Whenever a client requests retrieving the document from the system, the whole document token xᵢ will be retrieved to the client by the retrieval process. The client may then employ the verification algorithm listed in FIG. 4B to validate the token.

The verification algorithm in FIG. 4B illustrated how digital aging, which is provided by the present invention, protects electronic documents for long term using two layer of signature and timestamp. In contrast, a scheme with one layer of signature and timestamp cannot achieve such property.

First, the present invention protects the document from failure of a system using one layer of signature and timestamp. A system with only one layer of signature and timestamp relies heavily on the assumption that an attack on the cryptographic primitive used is not feasible. This assumption may be valid for short term archival, but may not be valid in long term archival as the technology advances. In the present invention, when such assumption is no longer valid, the other layer of signature and timestamp could provide additional protection when one layer of the signature and timestamp is compromised.

Second, the system with only one layer of signature and timestamp will suffer from a single point of failure as the security relies on the fact that the signing key is not compromised and not expired. In the present invention, such failure is eliminated as the security relies on two layers of signature and timestamp, and a renewal of digital aging token can be carried out to produce additional layers when the signing key of one layer is compromised.

Thirdly, the present invention supports the updating of cryptographic primitives while the integrity of the protected document can still be proved by the renewal technique of digital aging. This is essential for long term archival as technology updates should be required for long term protection.

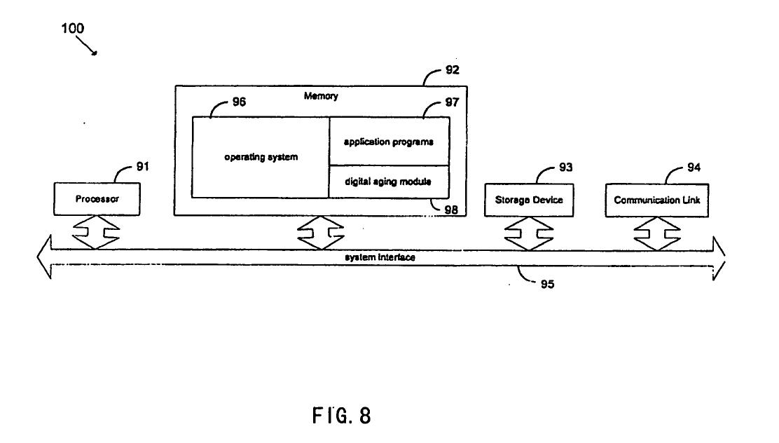

FIG. 8 illustrates a computer system 100, which includes the digital aging module 98 in accordance to the present invention. The computer system 100 includes a processor 91, a memory 92, a storage device 93, a-system interface 95, a communication link 94, a conventional operating system 96, application programs 97, and a digital aging module 98. Via the system interface 95, the processor 91 communicates with other components. The application programs 97 and the operating system 96 are loaded into the memory 92. The operating system 96 communicates with the application programs 97, and the processor 91 executes the application programs 97 through the operating system 96. The application programs 97 include the digital aging module 98. Like the application programs 97, the digital aging module 98 is executed by the processor 91 through the operation system 96. The storage device 93 acts as a secondary storage memory device for storing data. The communication link 94 is provided to enable the communication of the computer system 100 to other computer systems. An input device, such as a keyboard, mouse etc., and an output device, such as a display, speaker, printer, etc., may also included. Because these input and output devices are well known in the art, they are not described in detail here.

It will be apparent to a person skilled in the art that the digital aging module of the present invention may be embodied as a method, apparatus, or computer program. The digital aging module 98 may be embodied in the form of hardware, or software, or a combination of software and hardware. Moreover, the digital aging module 98 may take the form of computer program on a computer system storage device or medium having the computer program embodied thereof. The computer system storage device or medium, for use or in connection to the computer system, may include an electronic, magnetic, optical, or other means that can store or contain a computer program for use by the computer system or method.

The processor 91 may contain one or more computational processing units or computational devices. The memory 92 may be volatile, non-volatile, or a combination of both. The memory 92 and the storage device 93 are both computer readable medium, which includes, but is not limited to, RAM, ROM, EBPROM, flash memory, or other memory technology, CDROMs, DVDs, or other optical storage, magnetic cassettes, magnetic tape, magnetic disk storage, or other magnetic storage devices, or any other medium which can be used to store the desired information and which can be accessed by the processor 91. The memory or the storage device may store the application programs 97 or its portion for the execution of the application program. A portion of the memory 92 or the storage device 93 may be utilized by the processor 91, the operating system 96, the application programs 97 for executing the digital aging module 98. When the application programs 97 or the digital aging module 98 is in a stage other than the execution stage, the program or the module may reside in the memory or the storage device.

The application programs 97 may be any suitable computer programs, which can be executed by the processor 91 through the operating system 96, to carry out the digital aging process including normal aging 28 and exceptional aging 29. The application programs 91 may includes, for example, the digital aging program, the document archival program, and document retrieval program, in order to carry out the digital aging process.

The digital aging module 98 is a component of the application programs 97 or may be one of the application programs 97 itself. The digital aging module 98 may be invoked automatically when the application is invoked or can be invoked by a user. The user may invoke the program via the communication link 94, or via an input device such as keyboard connected to the system.

According to the present invention, the digital aging module 98 carries out the digital aging process as described in FIG. 1, which includes, but is not limited to, the generation of digital aging token, verification of digital aging token and digital aging scheduler. The application collects certificate revocation information and certificate by communicating with an external certificate authority through the communication link, to enable the digital aging module to carry out the digital aging process. Moreover, the application also communicate with an external timestamping authority for the generation of time stamp which is required by the digital aging module.

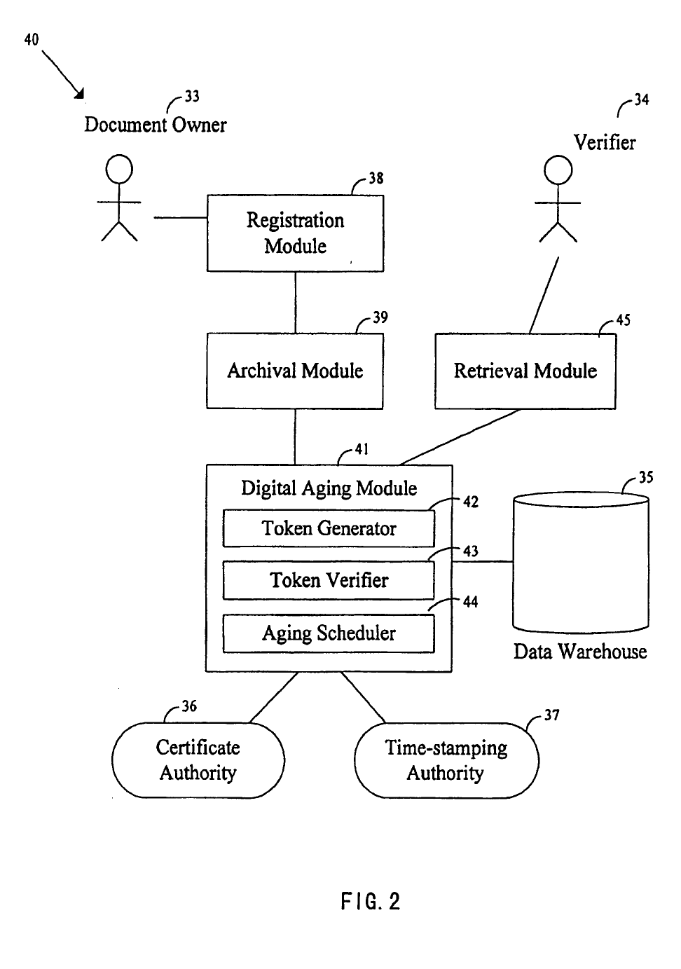

FIG. 2 illustrates the software architecture 40 of a document archival system implementing a digital aging scheme. The system consists of two external types of users: document owner 33 and document verifier 34. In addition, there should be at least two external entities: the certificate authority 36, which is responsible for issuing certificates and certificate revocation information, and the timestamping authority 37, which is responsible for issuing timestamp and verifying timestamp. In our system, we do not specify whether the timestamping authority 37 employs a special digital timestamping technique. However, the timestamp issued by timestamping authority 37 must be time stamped.

In one embodiment, the system consists of four modules and a data warehouse 35. The registration module 38 is responsible for the registration process mentioned in FIG. 1. The retrieval module 45 is responsible for document retrieval as in the document retrieval process in FIG. 1. Apart from being a traditional digital archival system, the archival module 39 connects to the digital aging module 41 where digital aging is carried out. Inside the digital aging module, there are three sub-modules: Token generation 42, token verifier 43 and aging scheduler 44. Specifically, the digital aging module is equivalent to the digital aging module in FIG. 8 and resides in the computer system in FIG. 8.

The token generation module 42 performs the logic in the normal aging module 28 and exceptional aging process 29 in FIG. 1, which includes, but is not limited to, collecting certificates used, certificate revocation information used, generating two layers signature and timestamps. The token verifier 43 performs the logic in the verification process 26 in FIG. 1, and the aging scheduler 44 performs the schedule update process 32 in FIG. 1.
The data warehouse 35 contains the document aging tokens, certificates and the certificate revocation information.

FIG. 2 also illustrates the difference between the digital archival system without digital aging and the one with digital aging scheme. In the system without digital aging, the archival module 39 and retrieval module 45 are connected to the data warehouse. In the present invention, the archival module 39 and the retrieval module 45 are connected to the digital aging module 41, which is connected to the data warehouse. This also illustrates how the present invention can be implemented into existing software architecture.

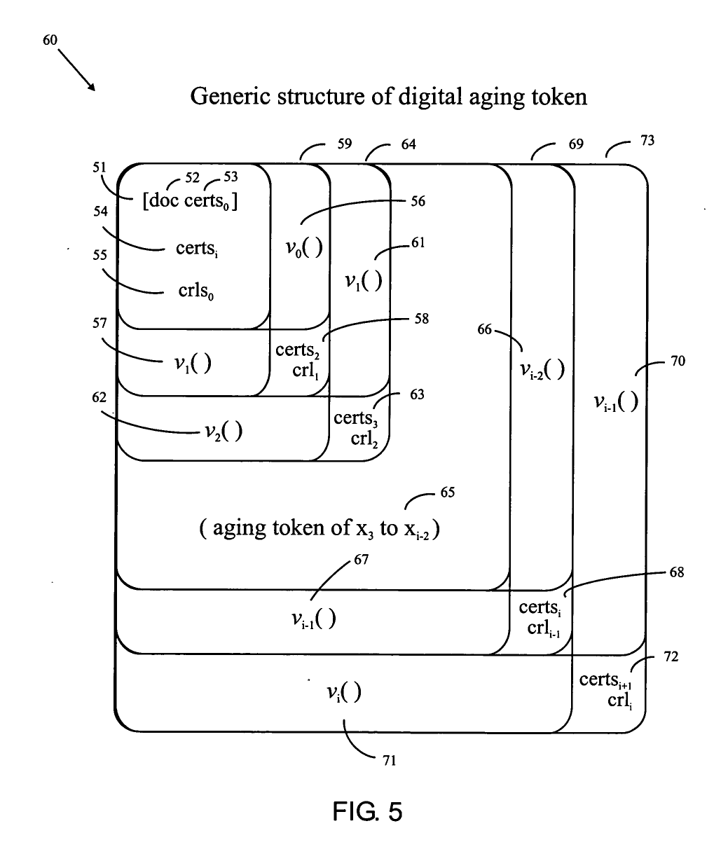

FIG. 5 illustrates the generic structure of a digital aging token. The first layer of the digital aging token 51 is xₒ, which consist of the document 52 and the certificate 53 used. As illustrated in previous section, the generation of xₒ's next digital aging token of 59, which is denoted as xᵢ, involve the collection of certificate 54 that will be used and the revocation information 55 of the certificate used in the digital aging token 51 xₒ. With all of this information, the next digital aging token 59 xᵢ is generated by the αᵢ function 20 with i=1, which is comprised of the νₒ and νᵢ functions. The outputs of these two functions are illustrated as the shaded area 56, 57. According to the present invention, the digital aging token 59 is then scheduled for another update. When such update is necessary, the information stored in the token xᵢ 59 will be retrieved according to this structure. Upon verification, one of the shaded areas 56, 57 will be retained for the generation of next digital aging token, which is described in digital aging layering algorithm in FIG. 4A. The certificate used in this update will be stored in the area 58. The next digital aging token 64 x₂ is generated by the a₂ function 20 with i=2 which comprise the νᵢ and ν₂ functions. The outputs of these two functions are illustrated as the shaded area 61, 62. As times goes by, digital aging is carried out again and again. After the i-th iteration of digital aging is carried out, the generic structure of the digital aging token xᵢ is illustrated as 73, where xᵢ contains the output of νᵢ₋₁ and νᵢ functions and the digital aging token 69 xᵢ₋₁. Every other digital aging token xⱼ, which is inside xᵢ, also contains this structure except that it may only consist of one output of the νⱼ₋₁ and νⱼ functions.

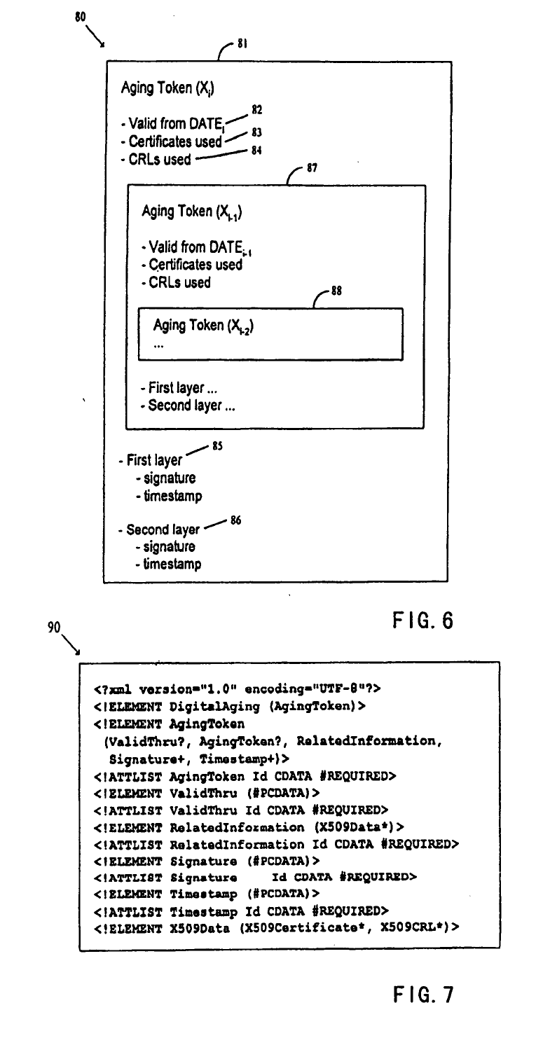

FIG. 6 illustrates the generic layout 80 of a digital aging token. This layout is the graphical representation of the data structure of a digital aging token, which can be implemented by computer. A generic aging token xᵢ consists of the following data: (1) “the valid from” 82 of the aging token (2) the certificates used 83 in xᵢ (3) the CRL used 84 in xᵢ, which is referring to the certificate used in xᵢ₋₁ (4) the first layer 85 signature and timestamp, which is the output of νᵢ (5) the second layer 86 signature and time stamp, which is the output of νᵢ₊₁ (6) and another digital aging token 87 which this digital aging token renewed.

FIG. 7 illustrates the XML data type definition 90 (DTD) of digital aging token. The XML consist of a root element “DigitalAging”, which has a child element “AgingToken”. The structure of “AgingToken” element is a modification of the generic layout in FIG. 6, and it consists of child elements: “ValidThru”, “AgingToken”, “RelatedInformation”, “Signature” and “Timestamp”. Each of these elements contains an attribute “Id”, which labels the layer of the digital aging token to which they belongs. “RelatedInformation” consist of one or more “X509Data” child element, which stores the certificates and certificate revocation information.

While the invention has been described with reference to a preferred embodiment, it is to be understood that various different modifications are possible and are contemplated as being within the spirit and scope of the invention, as set forth in the appended claims.

### REFERENCE

### OTHER PUBLICATIONS

D. Bayer, S. Haber, and W. S. Stometta. Improving the efficiency and reliability of digital time-stamping. In Sequences9l: Methods in Communication, Security, and Computer Science, pages 329-334, 1992.
Ahto Buldas, Peeter Laud, and Helger Lipmaa. Accountable certificate management using undeniable affestations. In ACM Conference on Computer and Communications Security, pages 9-17, 2000.
Ahto Buldas, Peeter Laud, Helger Lipmaa, and Jan Villemson. Timestamping with Binary Linking Schemes. In Advances on Cryptology CRYPTC) '98, volume 1462 of Lecture Notes in Computer Science, pages 486-501, 1998.
Bruno Crispo and T. Mark A. Lomas. A certification scheme for electronic commerce. In Security Protocols International Workshop, volume 1189 of Lecture Notes in Computer Science, pages 19-32, 1996.
Stuart Haber and W. Scott Storneffa. How to time-stamp a digital document. Journal of Cryptology, 3(2)99-111, 1991.
Mike Just. Some timestamping protocol failures. In Internet Society Symposium on Network and Distributed System Security, 1998.
Adrian McCullagh and William Caelli. Non-repudiation in the digital environment. First Monday, 5(8), August 2000.
W. Polk D. Solo R. Housley, W. Ford. Rfc 2459: Internet x.509 public key infrastructure certificate and cr1 profile. 1999.
R. L.--Rivest, A: Shamir-,--and L.-M._Adelman. A method—for_obtaining—digital signatures and public-key cryptosystems. Technical Report MIT/LCS/TM-82, 1977.

1. A method for long term electronic document archiving, comprising:
collecting certificate revocation information for a certificate from a certificate authority, the certificate revocation information indicating the validity of the certificate used in an electronic document, where the certificate revocation information is not limited the CRL;
collecting a certificate that will be used from certificate authority;
generating at least two layers of signature and timestamp from the electronic document, certificate revocation information collected, and the certificate collected, where cryptographic primitives of different strength are used, and the two layers of signature and timestamp generated are of different cryptographic strength, where the signature is generated using a system signing key, where the timestamp is generated by an external entity; and
forming a digital aging token by combining the original electronic document, certificate revocation information, and certificate collected to the layers generated.

2. The method of claim 1, further comprising scheduling the next time moment a renewal is necessary, the next time moment for renewal determined by a most recent expiry date of the certificate collected.

3. The method of claim 1, further comprising verifying the digital aging token using the certificate revocation information from the certificate-authority.

4. The method of claim 1, further comprising verifying a second digital aging token stored in the digital aging token using the certificate revocation information stored in the digital aging token.

5. The method of claim 1, further comprising:
renewing the digital aging token at a scheduled time;
verifying the digital aging token using the certificate revocation information from the certificate-authority; and
verifying the digital aging token stored in the digital aging token using the certificate revocation information stored in the digital aging token.

6. The method of claim 1, further comprising handling of a compromised signing key for which a particular digital aging token has used by renewing the particular digital aging token immediately.

7. The method of claim 5, further comprising discarding one of the two layer of signature and timestamp during the renewal process, where only a valid layer of lower strength is preserved.

8. The method of claim 1, further comprising updating the signing key and cryptographic primitive.

9. A apparatus for long term archiving of an electronic document using a generating digital aging token, comprising
means for collecting certificate revocation information from a certificate authority;
means for collecting a certificate from the certificate authority;
means for generating at least two layers of signature and timestamp from the electronic document, collected certificate revocation information, and the certificate, where cryptographic primitives of different strength are used, and the two layers of signature and timestamp generated are of different cryptographic strength, where the signature is generated using the system signing key, where the timestamp is generated by an external entity; and means for forming a digital aging token by combining the electronic document, certificate revocation information, and certificates collected to the layers generated.

10. The apparatus of claim 9 further comprising means for scheduling a next time moment a renewal is necessary, the next time moment for renewal is determined by a most recent expiry date of the certificate collected.

11. The apparatus of claim 9, further comprising means for verifying the digital aging token using the certificate revocation information from the certificate authority.

12. The apparatus of claim 9, further comprising means for verifying a second digital aging token stored in the digital aging token using the certificate revocation information stored in the digital aging token.

13. The apparatus of claim 9, further comprising:
means for renewing the digital aging token at a scheduled time;
means for scheduling a next time moment a renewal is necessary, the next time moment for renewal is determined by a most recent expiry date of the certificate collected; and
means for verifying the digital aging token using the certificate revocation information from the certificate authority.

14. The apparatus of claim 9, further comprising means for handling a compromised signing key for which a particular digital aging token was used by renewing the particular digital aging token immediately.

15. The apparatus of claim 13, further comprising means for discarding one of the two layers of signature and timestamp during the renewal process, where only a valid layer of lower strength is preserved.

16. The apparatus of claim 9, further comprising means for updating a signing key and cryptographic primitive to be used.

17. A computer program product for long term archiving of an electronic document, comprising a computer readable storage medium having computer readable program, wherein the said computer readable program code means comprises:
computer readable program code means for collecting certificate revocation information from a certificate authority;
computer readable program code means for collecting a certificate from the certificate authority;
computer readable program code means for generating at least two layers of signature and timestamp from the electronic document, certificate revocation information collected and the certificate collected, where cryptographic primitives of different strength are used, and the two layers of signature and timestamp generated is of different cryptographic strength, where the signature is generated using the system signing key, where the timestamp is generated by an external entity, forming the digital aging token by combining the original electronic document, certificate revocation information, and certificates collected to the layers generated.

18. The computer program product of claim 17, further comprising means for scheduling a next time moment a renewal is necessary, the next time moment for renewal is determined by a most recent expiry date of the certificate collected.

19. The computer program product of claim 17, further comprising means for verifying the digital aging token by using the certificate revocation information from the certificate authority.

20. The computer program product of claim 17, further comprising computer readable program code means for verifying the digital aging token stored in the digital aging token by using the certificate revocation information stored in this digital aging token.

21. The computer program product of claim 17, further comprising:
computer readable program code means for renewing the digital aging token at the scheduled time, computer readable program code means for verifying the digital aging token by using the certificate revocation information from the certificate authority; and
computer readable program code means for verifying the digital aging token stored in the digital aging token by using the certificate revocation information stored in this digital aging token.

22. The computer program product of claim 17, further comprising computer readable program code means for handling of a compromised signing key for which a particular digital aging token was used by renewing the particular digital aging token immediately.

23. The computer program product of claim 21, further comprising computer readable program code means for discarding one of the two layer of signature and timestamp during the renewal process, where only a valid layer of lower strength is preserved.

24. The computer program product of claim 17, further comprising computer readable program code means for updating a signing key and cryptographic primitive to be used.

25. A system for carrying out digital aging, registration of electronic document for digital aging, archiving, verifying and storing digital aging token comprising:
a central server;
a central database accessible by the said central server;
an external certificate authority accessible by the said central server;
an external timestamping authority accessible by the said central server;
software executing on the said central server for registration of electronic document for digital aging;
software executing on the said central server for archiving the electronic document;
software executing on the said central server for storing digital aging token on the said central database;
software executing on the said central server for retrieving digital aging token on the said central database;
software executing on the said central server for generating digital aging token;
software executing on the said central server for verifying digital aging token;
software executing on the said central server for generating signatures; software executing on the said central server for retrieving certificates and certificate revocation information from said certificate authority; and
software executing on the said central server for requesting timestamp from the said timestamping authority.

26. An algorithm for generating the digital aging token from the electronic document.

27. The algorithm of claim 26, further comprising of the generation of a second digital aging token from the digital aging token to extend validity of the digital aging token.

28. An algorithm for verification of the digital aging token.

29. A data structure of digital aging token, which links the document, digital signatures and digital timestamps and the other digital aging token related.

30. An XML layout of the data structure of claim 29.
